(19) United States
(12) Patent Application Publication
(10) Pub. No.: US 2024/0172587 A1
(43) Pub. Date: May 30, 2024

(54) ELECTRIC MOWER

(71) Applicant: Briggs & Stratton, LLC, Wauwatosa, WI (US)

(72) Inventors: Jeffrey ZEILER, Wauwatosa, WI (US); Bryan Keith Dandridge, Wauwatosa, WI (US); Scott Funke, New Berlin, WI (US); Jacob Schmalz, Milwaukee, WI (US); Mark Noller, Wauwatosa, WI (US)

(73) Assignee: Briggs & Stratton, LLC, Wauwatosa, WI (US)

(21) Appl. No.: 18/430,823

(22) Filed: Feb. 2, 2024

Related U.S. Application Data
(63) Continuation of application No. 16/599,094, filed on Oct. 10, 2019.
(60) Provisional application No. 62/744,700, filed on Oct. 12, 2018.

(51) Int. Cl. A01D 34/78; A01D 34/00; A01D 34/82; A01D 101/00

(52) U.S. Cl. CPC A01D 34/78; A01D 34/006; A01D 34/824; A01D 2101/00

(57) ABSTRACT

A lawnmower includes a cutting deck including an aperture extending through the cutting deck, the aperture comprising a first motor portion, a second motor portion, and a central portion joining the first motor portion and the second motor portion. The lawnmower further includes a first electric motor received within the first motor portion and coupled to a first cutting blade positioned below the cutting deck and a second electric motor received within the second motor portion and coupled to a second cutting blade positioned below the cutting deck.

### CROSS-REFERENCE TO RELATED APPLICATIONS

This application is a continuation of U.S. application Ser. No. 16/599,094, filed Oct. 10, 2019, which claims the benefit of U.S. Provisional Application No. 62/744,700, filed Oct. 12, 2018, both of which are incorporated herein by reference in their entireties.

### BACKGROUND

The present application relates generally to outdoor power equipment. More specifically, the present application relates to electric outdoor power equipment in the form of an electric mower, which may be battery powered.

### SUMMARY

One embodiment of the disclosure is a lawnmower including a cutting deck, a cutting blade positioned below the cutting deck, and an electric motor couple to and configured to drive the cutting blade. The electric motor is positioned at least partially below the cutting deck.

Another embodiment of the disclosure is a lawnmower including an electric motor configured to operate a component of the lawnmower. The electric motor is a liquid-cooled motor.

Another embodiment of the disclosure is a lawnmower including one or more electric motors configured to operate a component of the lawnmower, a controller configured to control operation of the one or more electric motors, and a programmable user interface configured to display operational parameters of the lawnmower. The one or more electric motors are connected to the controller via a network communication bus.

Alternative exemplary embodiments relate to other features and combinations of features as may be generally recited in the claims.

### BRIEF DESCRIPTION OF THE DRAWINGS

The disclosure will become more fully understood from the following detailed description when taken in conjunction with the accompanying figures.

FIG. 1 is a front perspective view of outdoor power equipment in the form of an electric stand-on mower, according to an exemplary embodiment.

FIG. 2 is rear perspective view of the electric stand-on mower of FIG. 1, according to an exemplary embodiment.

FIG. 3 is a side view of the electric stand-on mower of FIG. 1, according to an exemplary embodiment.

FIG. 4 is a side view of a portion of the electric stand-on mower of FIG. 1, according to an exemplary embodiment.

FIG. 5 is a side view of a portion of the electric stand-on mower of FIG. 1, according to an exemplary embodiment.

FIG. 6 is a side view of a portion of the electric stand-on mower of FIG. 1, according to an exemplary embodiment.

FIG. 7 is a perspective view of a motor and a motor controller for use with the electric stand-on mower of FIG. 1, according to an exemplary embodiment.

FIG. 8A is a perspective view of a motor assembly for use with the electric stand-on mower of FIG. 1, according to an exemplary embodiment.

FIG. 8B is a schematic diagram of a motor assembly for use with the electric stand-on mower of FIG. 1, according to an exemplary embodiment.

FIG. 8C is a schematic diagram of a motor assembly for use with the electric stand-on mower of FIG. 1, according to an exemplary embodiment.

FIG. 9 is a schematic diagram of the motor assembly of FIG. 8, according to an exemplary embodiment.

FIG. 10A is a schematic diagram of a top view of a cutter deck of the mower of FIG. 1, according to an exemplary embodiment.

FIG. 10B is a perspective view of a blade removal assembly for use with the mower of FIG. 1, according to an exemplary embodiment.

FIG. 10C is a perspective view of a blade removal assembly for use with the mower of FIG. 1, according to an exemplary embodiment.

FIG. 10D is a perspective view of a blade removal assembly for use with the mower of FIG. 1, according to an exemplary embodiment.

FIG. 10E is a perspective view of a blade removal assembly for use with the mower of FIG. 1, according to an exemplary embodiment.

FIG. 10F is a perspective view of a blade removal assembly for use with the mower of FIG. 1, according to an exemplary embodiment.

FIG. 10G is a perspective view of a blade removal assembly for use with the mower of FIG. 1, according to an exemplary embodiment.

FIG. 11 is a perspective view of a dashboard of the electric stand-on mower of FIG. 1, according to an exemplary embodiment.

FIG. 12 is a front view of a dashboard of the electric stand-on mower of FIG. 1, according to an exemplary embodiment.

FIG. 13A is a schematic diagram of a control system for the mower of FIG. 1 and the dashboard of FIG. 11, according to an exemplary embodiment.

FIG. 13B is a schematic diagram of a controller of the control system of FIG. 13A, according to an exemplary embodiment.

FIG. 14 is a user interface of the dashboard of the electric stand-on mower of FIG. 1, according to an exemplary embodiment.

FIG. 15 is a user interface of the dashboard of the electric stand-on mower of FIG. 1, according to an exemplary embodiment.

FIG. 16 is a user interface of the dashboard of the electric stand-on mower of FIG. 1, according to an exemplary embodiment.

FIG. 17 is a user interface of the dashboard of the electric stand-on mower of FIG. 1, according to an exemplary embodiment.

FIG. 18 is a user interface of the dashboard of the electric stand-on mower of FIG. 1, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Although the description and figures herein describe the structure and operation of a stand-on electric mower, it should be understood that the components describe herein could be utilized with other types of outdoor power equipment such as riding tractors, snow throwers, pressure washers, tillers, log splitters, zero-turn radius mowers, walk-behind mowers, riding mowers, pavement surface preparation devices, industrial vehicles such as forklifts, utility vehicles, commercial turf equipment such as blowers, vacuums, debris loaders, overseeders, power rakes, aerators, sod cutters, brush mowers, sprayers, spreaders, etc.

Referring to the figures generally, an electric mower is illustrated. The electric mower includes one or more chore motors (e.g., chore motor assemblies) that are positioned substantially below the deck of the mower (e.g., “sub-flush” relative to the top surface of the deck). The positioning of the chore motors and the integration of the spindles and motors as single assemblies, as described further herein, allows for easy replacement of cutting blades through an aperture in the deck without the operator having to reach below the deck. In some embodiments, the chore motors (and/or the drive motors) are liquid-cooled allowing for higher output from the motors and thus, for the use of smaller motors than is conventionally used, which may produce similar outputs due to being liquid-cooled (e.g., as opposed to air-cooled). The motors are powered by an energy storage device, such as a battery, which may also be liquid-cooled. The operation of the electric mower is controllable through a user interface on the dashboard of the mower. A control system receives user inputs and performance data and controls various aspects and components of the mower based on that input and data. The electric mower is also automatically controlled in various ways to improve upon the performance, value, and maintenance of the mower as described herein.

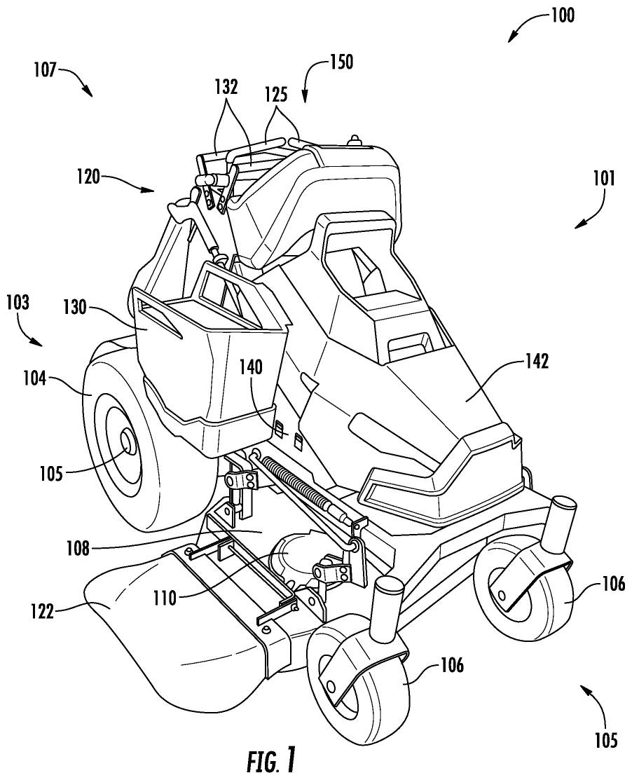

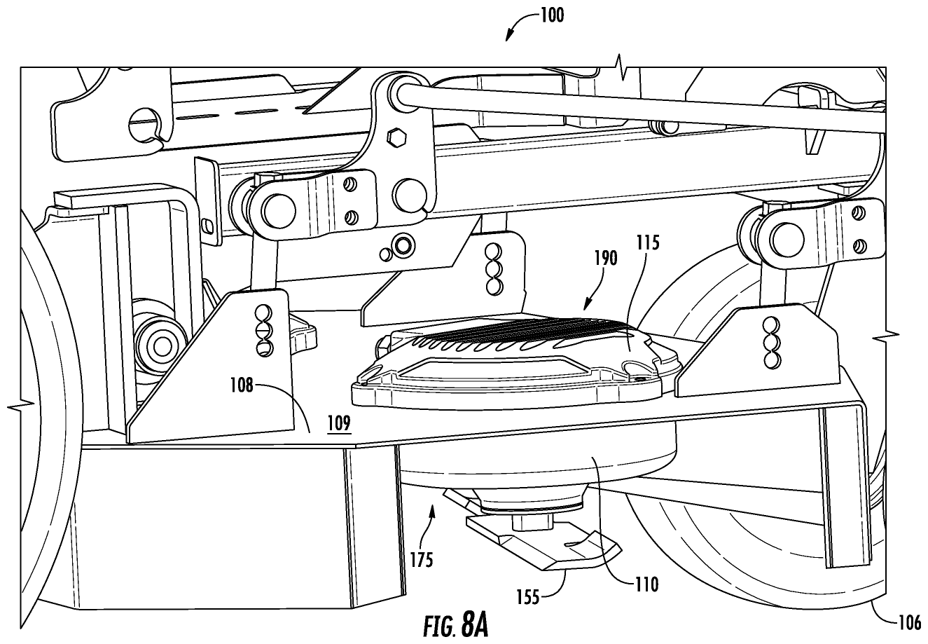

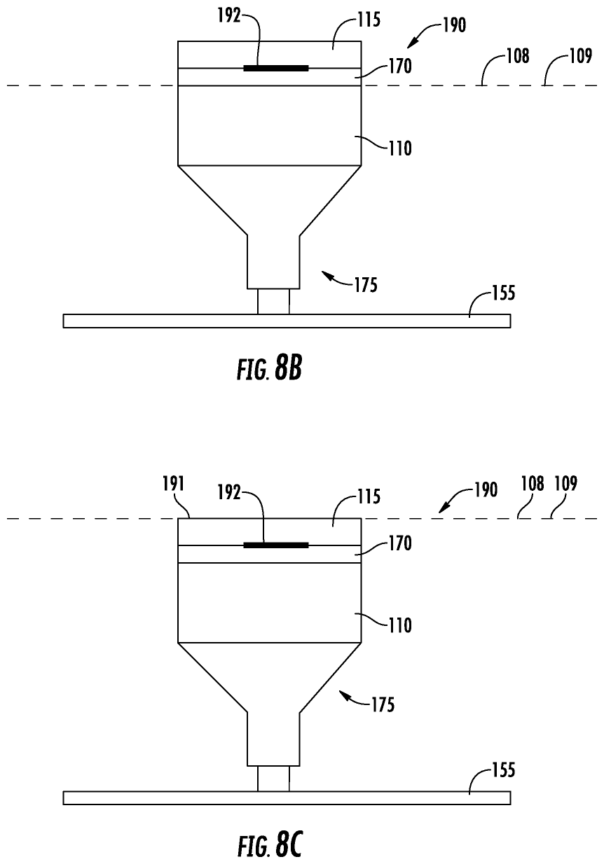

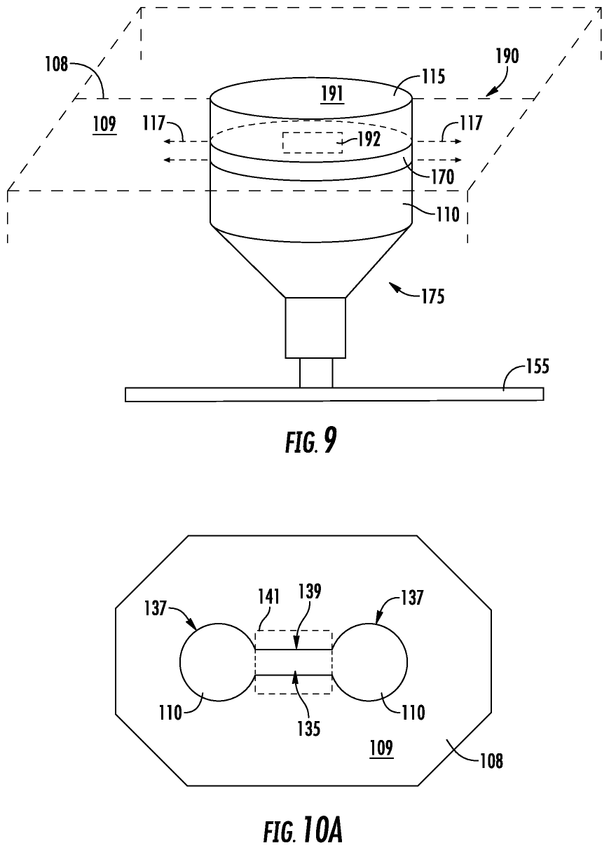

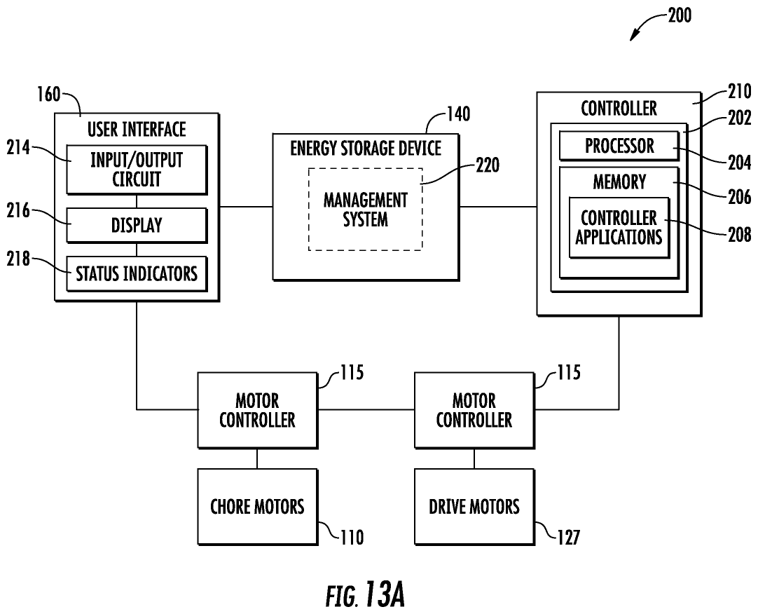

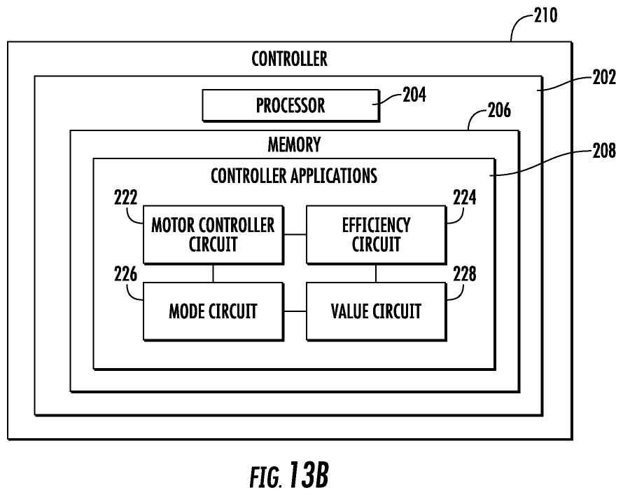

FIG. 1 illustrates a piece of outdoor power equipment, in the form of a stand-on electric mower 100, which includes one or more drive motors 127 (shown in FIG. 13A) and one or more chore motors 110 electrically coupled to and powered by an energy storage device 140. The chore motors 110 are coupled to a rotary tool, such as the blade (e.g., cutting blade 155 shown in FIGS. 8A-9) in the deck 108 of the mower 100, an auger, a saw, tines, a drill, a pump, or other rotary tools. The mower 100 includes rear drive wheels 104 and front wheels 106. The rear drive wheels 104 are each driven by one of the drive motors 127. In other embodiments, the mower 100 can include more or less wheels and/or drive motors. In some embodiments, the front wheels 106 are driven.

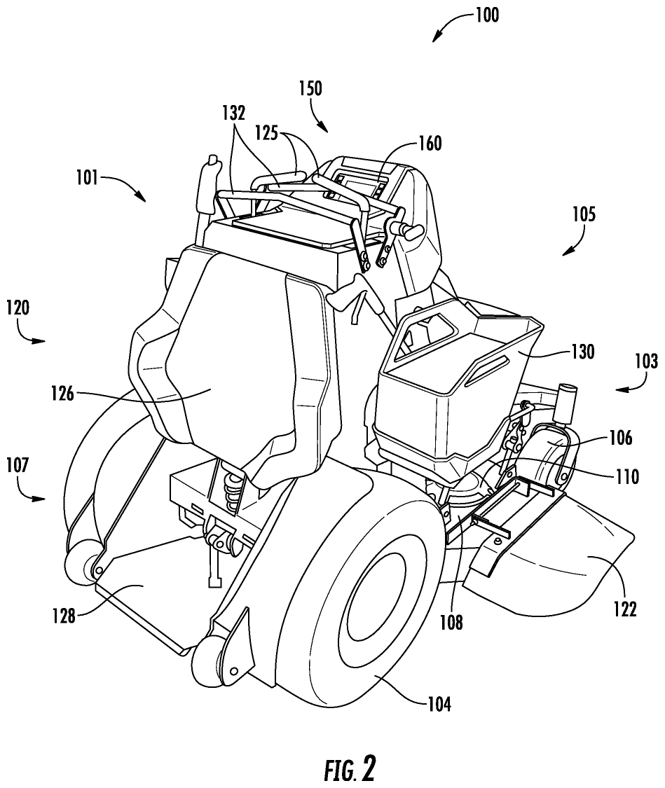

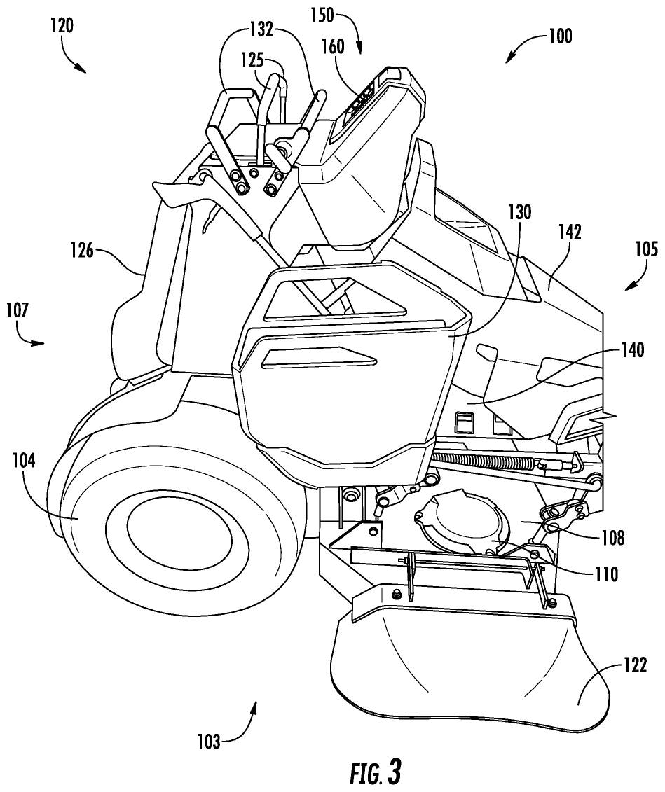

Referring to FIGS. 1-3, the mower 100 includes a left side 101, a right side 103, a front 105, and a rear 107. An operator area 120 is positioned proximate the rear 107 of the mower 100, where the operator faces toward the front 105 of the mower 100 while in operation. The operator area 120 includes a platform 128 on which the operator stands while operating the mower 100. The platform 128 may include sensors to detect when the operator is positioned on the platform 128 (e.g., to operate chore motors 110, etc.). Padding 126 may support the operator while the operator is standing on the platform 128 such that the operator may rest a portion of his or her body on the padding 126 while operating the mower 100. In some embodiments, the operator area 120 is positioned proximate the rear drive wheels 104. In some embodiments, the axle 111 of the rear drive wheels 104 is positioned forward of the operator area 120 and platform 128. In some embodiments, a portion of the rear drive wheels 104 is positioned substantially underneath an operator while standing on the platform 128. In some embodiments, the mower 100 includes an accessory container 130 accessible by the operator for placing items such as garbage, debris, etc. In some embodiments, the accessory container 130 is removably mounted onto a frame of the mower 100.

The mower 100 is shown to include an energy storage device 140 (e.g., battery). The energy storage device 140 is shown positioned beneath a hood 142 of the mower 100. The hood 142 may allow air to flow therethrough for ventilation and/or cooling purposes. The energy storage device 140 provides energy (e.g., electrical energy) to the components of the mower 100 including, but not limited to, the chore motors 110, drive motors 127, motor controllers 115, user interface 160, control system 200, etc. The energy storage device 140 can be liquid-cooled. The energy storage device 140 can be pre-heated for cold operation or during charging when cold using a heating element placed in the liquid flow path used for the liquid-cooled system. In some embodiments, energy storage device 140 includes a management system 212 (shown in FIG. 13A) to control and monitor the operation thereof. The control system 200 described further herein can dynamically interface with the management system 212 to ensure optimal operation of the mower 100 while protecting the energy storage device 140. The energy storage device 140 can be a battery or battery module and can include one or more distinct batteries including one or more battery cells (e.g., lithium ion battery cells and/or any other type of battery cell as described herein or that is suitable).

The energy storage device 140 can be a lithium-ion (Li-ion) battery, a lithium-ion Polymer (Li-pol) battery, a lead-acid battery, a nickel-cadmium (NiCd) battery, a nickel-metal hydride (NiMh) and/or any other type of battery configured to store and/or discharge energy. The energy storage device has a capacity of 7.2 kWh. In other embodiments, the energy storage device 140 may have various capacities, e.g., 0.1 kWh, 0.5 kWh, 1 kWh, 3 kWh, 10 kWh, 50 kWh, etc. The energy storage device 140 may also be a capacitor, ultracapacitor, bank of capacitors, etc.

The mower 100 includes drive levers 125 (e.g., right drive lever, left drive lever) movable by the operator to change the speed of the mower 100 in a forward and backward direction and to change direction of the mower 100 in forward, backward, right, and left directions. The mower 100 also includes one or more handles 132 designed to be grasped by an operator standing on the platform 128. The handles 132 surround the drive levers 125, extending forward and rearward of the drive levers 125 and act as reference points to which the drive levers 125 may be moved forward and backward, thereby limiting the top speeds in the forward and backward direction of the mower 100. The handles 132 may be adjusted forward or backward by the operator to limit the forward and backward movement of the drive levers 125. In this way, the handles 132 may be adjusted for varying levels of experience (e.g., novice, experienced operators) and/or for varying types of jobsites (e.g., flat terrain, steep hills, small lawns, large lawns, etc.).

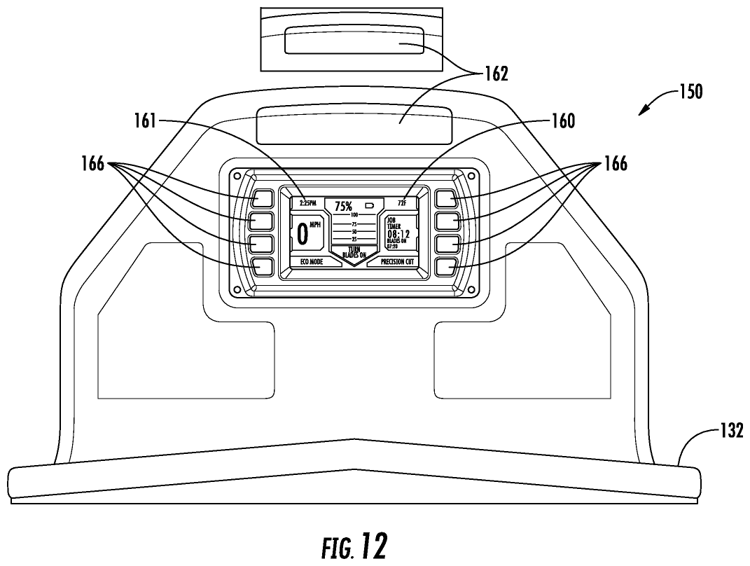

The drive levers 125 are coupled to drive motors 127 (shown in FIG. 12), which are coupled to (e.g., engage with) and control the rotation of the rear drive wheels 104. In some embodiments, the drive motors 127 are mounted onto the chassis of the mower 100 from the outside of the rear drive wheels 104. The drive wheels 104 rotate differently in response to various operator inputs at the drive levers 125. Accordingly, when the operator moves the drive levers 125 in a forward direction, the rear drive wheels 104 rotate in a forward direction to propel the mower 100 forward. When the operator moves the drive levers 125 in a backward direction, the rear drive wheels 104 rotate in the backward direction to drive the mower 100 backward. In addition, when the right or left drive levers 125 are moved forward or backward separately (e.g., right drive lever is moved separately from the left drive lever), the drive motors and drive wheels 104 respond accordingly. For example, when the right drive lever is moved forward and the left drive lever remains stationary, the right rear drive wheel 104 is rotated faster than the left drive wheel 104 and the mower 100 is caused to move to the left, and vice versa. The drive levers 125 may also act to engage and/or disengage the blades 155 (FIGS. 8A-9). For example, if an operator returns the drive levers 125 to the neutral position, and lets go of one or more of the drive levers 125 the blades 155 may be disengaged.

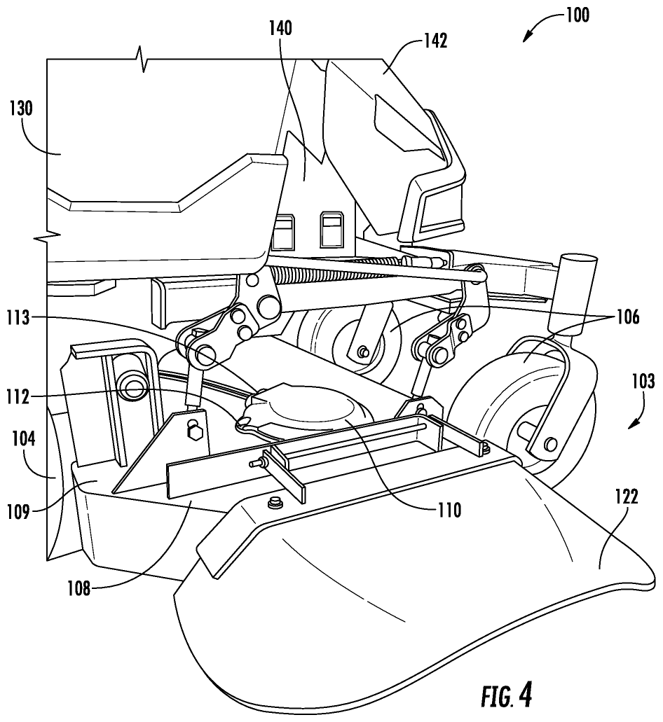

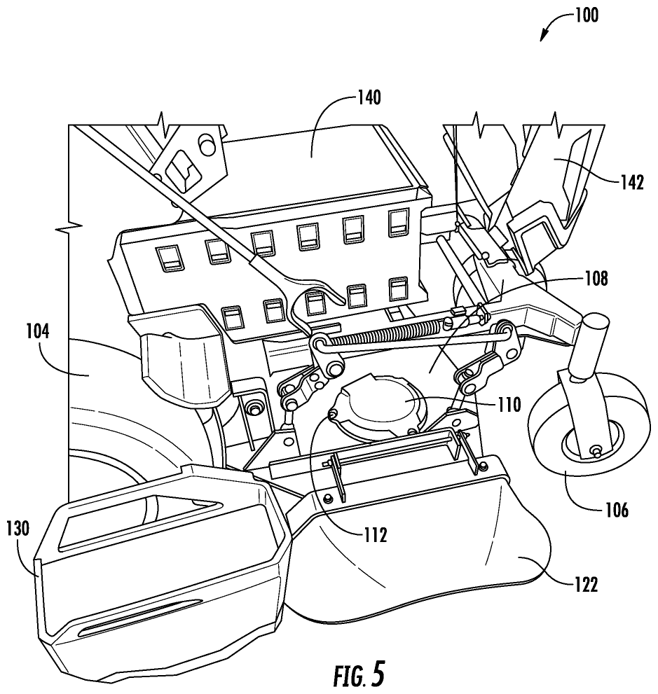

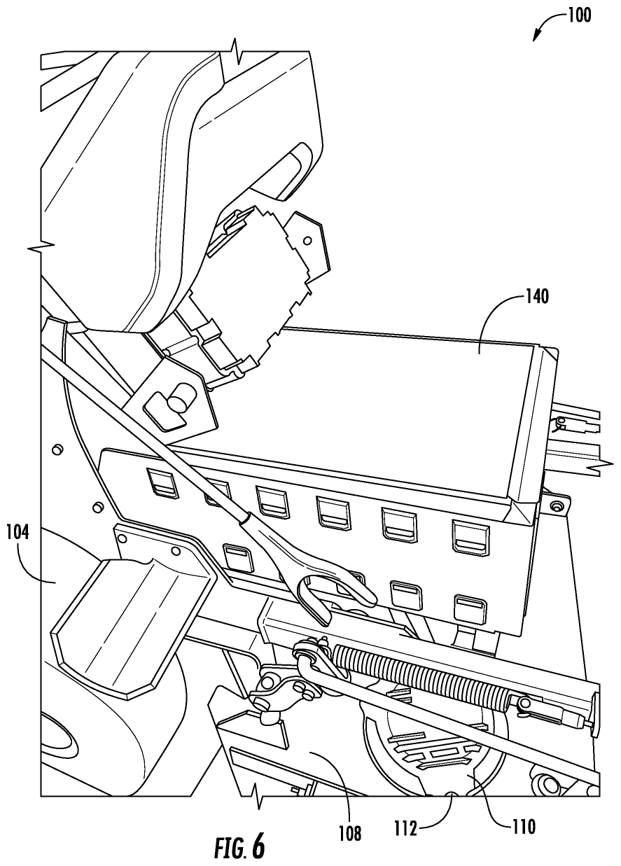

Referring to FIGS. 4-7, the mower 100 includes a cutting deck 108 and two chore motors 110 coupled to and configured to rotate cutting blades 155 (shown in FIGS. 8A-9) positioned beneath the deck 108. The cutting deck 108, chore motors 110, and blades 155 are positioned proximate the front 105 of the mower 100 (e.g., substantially opposite from the operator area 120). In some embodiments, more or less chore motors 110 may be included.

The chore motors 110 are liquid-cooled. In some embodiments, the drive motors 127 are liquid-cooled. In some embodiments, the motor assemblies 190, including both the motor 110 and integrated spindle 175 as described further herein, are liquid-cooled. Each of the motors 110, 127 include a rotor assembly, a stator assembly, and a housing. Passages may be formed in the motor housings to allow for liquid to move therethrough, thereby cooling the motors 110, 127. The liquid-cooling system may include a circulation pump in a liquid reservoir on-board the mower 100. In some embodiments, the liquid reservoir may have enough thermal mass to complete operation of the mower 100 for a certain predetermined amount of time under efficient operating conditions, such as for a day worth of cutting. For example, the liquid reservoir could hold approximately 3 to 5 gallons of water to absorb enough heat from the mower components (e.g., motors 110, 127) to allow for a full day of operation (e.g., approximately 50 watts). In some embodiments, the temperature change of the liquid in the reservoir (due to heat transfer from mower components) can be captured and used to increase the life of the energy storage device 140 on-board the mower 100. A thermoelectric effect (e.g., Peltier effect) can be used to directly convert the temperature differences into electricity (e.g., electric voltage) to be stored and/or used by the energy storage device 140.

The liquid cooling system can be positioned on the chassis of the mower 100 or on the deck 108. Thus, the liquid reservoir and circulation pump may be positioned on the chassis or deck 108 of the mower 100. The liquid cooling system may be completely enclosed on the deck 108 of the mower such that a structural member on the deck 108 acts as a cooling rail for the cooling system. Liquid-cooling the motors (e.g., chore motors 110, drive motors 127) can increase the output of the motors (e.g., from 1.2 kilowatts (kW) to 2.0 kW) allowing the motor to run with higher loads. Therefore, the size of the motors may be decreased allowing for similar outputs from a smaller sized motor as an output from a larger motor differently cooled. In some embodiments, a power-boost function can be enabled by turning on the liquid-cooling system. In some embodiments, the operator can turn the circulation pump on or off on demand to turn the liquid-cooling system on or off to increase the output of the motors 110, 127. The pump can also be a variable displacement pump, which can be used to vary the flow rate to vary the cooling rate of the liquid-cooling system. In addition to liquid-cooling, the chore motors 110 and/or drive motors 127 may also be air-cooled (e.g., cooling fins, air is passed over the motors via passages or ducts formed around/in the motors). In other embodiments, the motors 110, 127 may be otherwise cooled.

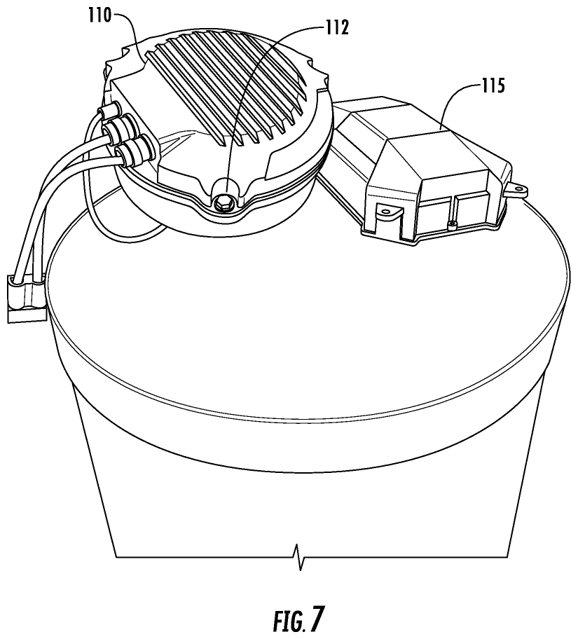

The chore motors 110 are electrically coupled to and powered by the energy storage device 140. The operation of the chore motors 110 are controlled by the motor controller 115 (shown in FIG. 7). Accordingly, the chore motors 110 are electrically, communicably, and operatively coupled to the motor controller 115. The motor controller 115 operates to control a chore motor 110 and can be located near or mounted on the chore motor 110 or mounted proximate the energy storage device 140 that provides the chore motor 110 with energy (e.g., electrical energy). In some embodiments, the motor controller 115 can be located on the deck 108 of the mower 100. The motor controller 115 can perform load based control of mower speeds, perform anti-scrubbing, can identify the size of the deck and optimizing cutting speed based on the width of the identified deck, and various other features. In some embodiments, each chore motor 110 and drive motor 127 have separate motor controllers 115. In some embodiments, one or more motor controllers 115 may be housed within a single controller module.

The motor controllers 115 described herein include a communications port 113. The communications port 113 can be configured to communicate with other motor controllers (e.g., via bus connections (e.g., a controller area network (CAN) bus)), can include analog inputs, analog outputs, digital inputs, digital outputs, a motor position connection, and/or motor sensor inputs. Using a communications bus can reduce and/or minimize cabling. In some embodiments, the communications port 113 includes two analog inputs, one analog output, digital input/output connections, CAN 2.0b connections, a motor position input, and motor sensor inputs.

Referring to FIGS. 8A-9, a chore motor assembly 190 is shown, according to an exemplary embodiment. The chore motor assembly 190 includes the motor 110 and an integrated spindle 175. The spindle 175 is integrated with (e.g., formed with, assembled with) the motor 110. In conventional motor and spindle coupling, the motor includes two bearings and the spindle includes two bearings, which all must be aligned with each other to couple the spindle and motor. Using an integrated spindle 175 in the chore motor 110, the number of bearings (and hence, required alignments) is reduced (from four bearings to two bearings) that support the spindle and motor rotor. Accordingly, the alignment of the bearings is made easier by the integration of the spindle 175 with the motor 110 due to the number of alignments necessary to complete the coupling or assembly of the motor 110 and spindle 175. In other embodiments, more or less bearings may be used. The integration of the motor 110 and spindle 175 also allows for improved access to the blades 155 (shown in FIG. 9) via an aperture 135 formed in the cutting deck 108 described further below.

The chore motor assembly 190 also includes a motor controller 115. The motor controller 115 includes an enclosure including one or multiple motor controllers for controlling electric motors of a piece of outdoor power equipment or other equipment suitable to be powered by electric motors. In some embodiments, the motor controller 115 is located near a motor (or other element or component) that the motor controller 115 is operating (reducing susceptibility due to shorter signal lines) and only requires motor connections, power connections, and/or CAN connections. This distance and/or small number of required connections can decrease electromagnetic interference, thereby improving electromagnetic compatibility. If the motor controller 115 operates to control a drive motor, the motor controller 115 may be located near the drive motor or mounted on a battery that provides the drive motor with energy. In some embodiments, the motor controller 115 is connected directly to multiple battery cells (via a control board of the motor controller 115) for operating motors.

In some embodiments, the motor controller 115 can include a thermal bath (e.g., a thermal water bath) which can surround some and/or part of the motor controller 115 and/or components of the controller 115 to cool the controller 115. In some embodiments, the controller 115 can include a liquid cooling system configured to cool controllers of the controller 115 and dissipate heat outside the controller 115. The motor controller 115 can be water tight and/or dust tight. This can prevent any electronic components within the motor controller 115 from becoming damaged. Since the motor controller 115 may be sealed, all communication between the components (e.g., controllers) of the motor controller 115 may be internal wiring/communication bus connections. In some embodiments, when the controllers of the motor controller 115 communicate to other external controllers, motors, and/or controller modules, a water tight and/or dust tight wiring interface can be utilized to wire the controllers of the motor controller 115 to the external components.

As shown in FIGS. 8A-9, the motor controller 115 is positioned (e.g., mounted) on top of the motor 110 and a cooling plate 170 is positioned therebetween. The motor controller 115 includes a control board 192 having electronics and control circuitry to control aspects of the motor 110 operation. The control board 192 is positioned directly on top of the cooling plate 170. In some embodiments, the motor controller 115 is inverted such that the control board 192 is positioned directly on top of the cooling plate 170. The cooling plate 170 includes water leads running therethrough to maintain a cool temperature. Accordingly, the cooling plate 170 acts to draw heat from the control board 192 and controller 115 to keep the temperature of the controller 115 at an effective operating temperature. In addition, the cooling plate 170 acts to draw heat from the motor 110 (e.g., motor windings) to keep the temperature of the motor 110 at an effective operating temperature. The cooling plate 170 expels heat through the sides of the plate 170 as shown by arrows 117 in FIG. 9. Thus, the cooling plate 170 can expel heat in a radial direction.

The chore motor assembly 190 is sub-flush relative to the deck 108. As used herein, the term “sub-flush” refers to a surface or a component being at least partially below a certain surface of another component. Accordingly, as shown in FIG. 8A, the chore motor assembly 190 is positioned at least partially below (or sub-flush relative to) the top surface 109 of the cutting deck 108. The chore motor assembly 190 may be fastened (e.g., bolted) to the deck 108 using fasteners 112. The chore motor assembly 190 extends below the deck 108, where the chore motor assembly 190 is coupled to the cutting blades 155.

In various embodiments, the chore motor assembly 190 is positioned at least partially below the top surface 109 of the deck 108. In some embodiments, a substantial portion of the chore motor assembly 190 is positioned below the top surface 109 of the cutting deck 108. In some embodiments, the motor 110 including the rotor and stator assemblies are positioned entirely below (e.g., sub-flush to) the cutting deck 108 (e.g., beneath the top surface 107 of the cutting deck 108), while the cooling plate 170 and the motor controller 115 are positioned at least partially above the deck 108 (as shown in FIG. 8B). In some embodiments, the control board 192 (and all electronics included within motor assembly 190) is positioned beneath the deck 108 (e.g., beneath the top surface 109 of the deck 108). In some embodiments (as shown in FIG. 8C), the chore motor assembly 190 is at least flush with the top surface 107 of the cutting deck 108, where a top surface 191 of the chore motor assembly 190 is flush with the top surface 107 of the cutting deck 108 and the rest of the chore motor assembly 190 is positioned underneath the deck 108 (e.g., underneath the top surface of deck 108).

In conventional applications, all components of the motor are positioned above the cutting deck, while the spindle is positioned below the deck. The positioning of the chore motor assembly 190 (and/or chore motor 110) relative to the cutting deck 108 as described herein allows for the deck 108 to be raised to a higher height for cutting higher grass. In addition, positioning the motor on top of the deck 108, as is conventionally done, allows grass or debris to accumulate on the motor, which causes the motor to become hotter than during normal operation without accumulation of grass or debris. By positioning the chore motor 110 at least partially under the deck 108, accumulation of grass or debris is less likely, thus allowing for better temperature management of the chore motor 110. Also by positioning the chore motor 110 at least partially under the deck 108, the air flow underneath the deck 108 may allow for better cooling of the chore motor 110.

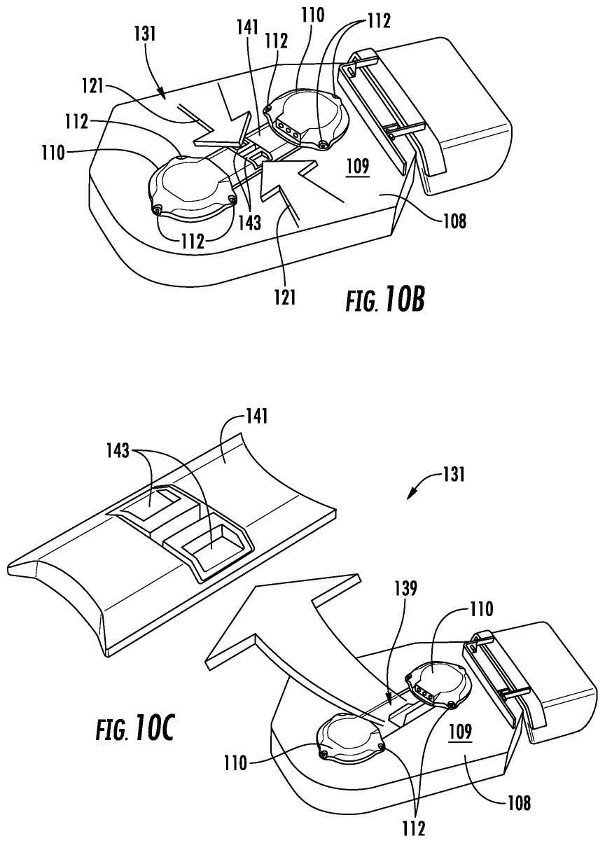

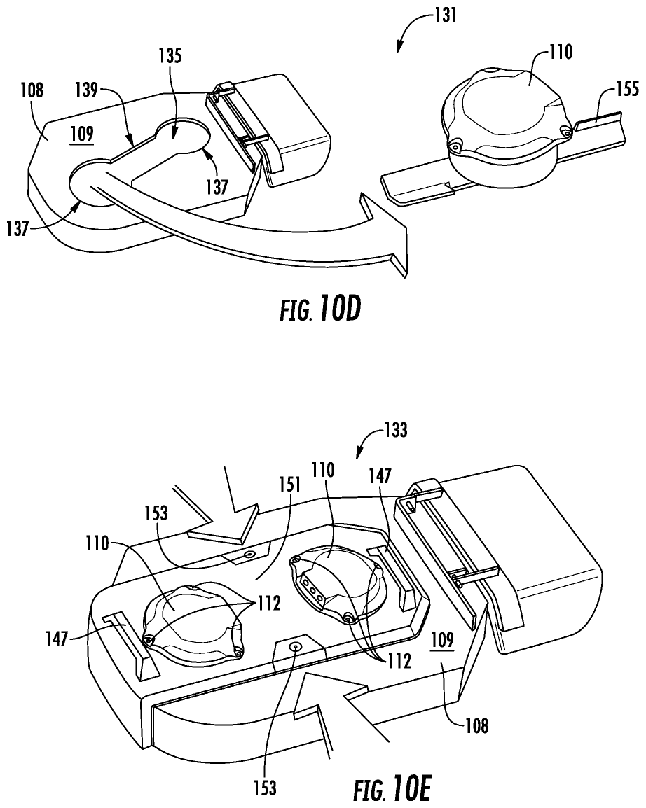

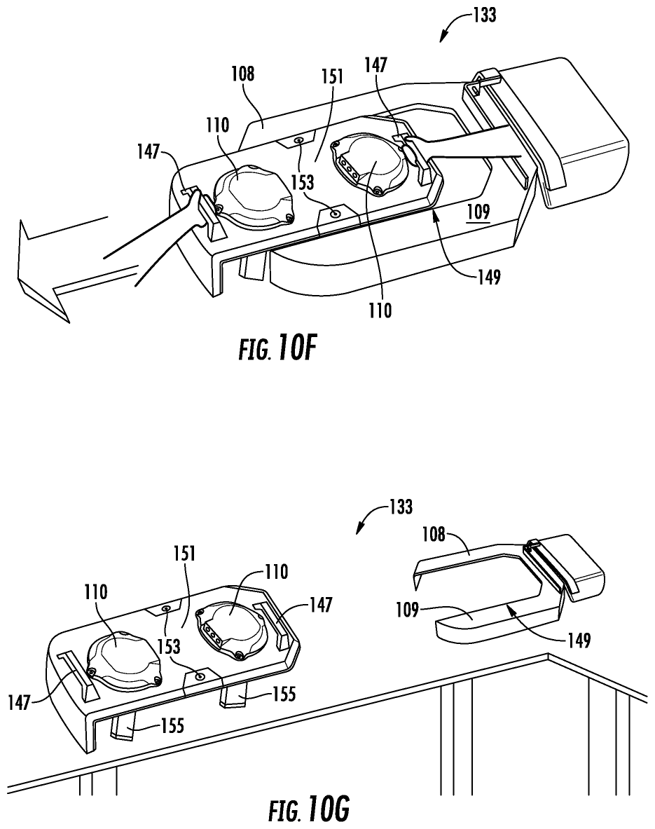

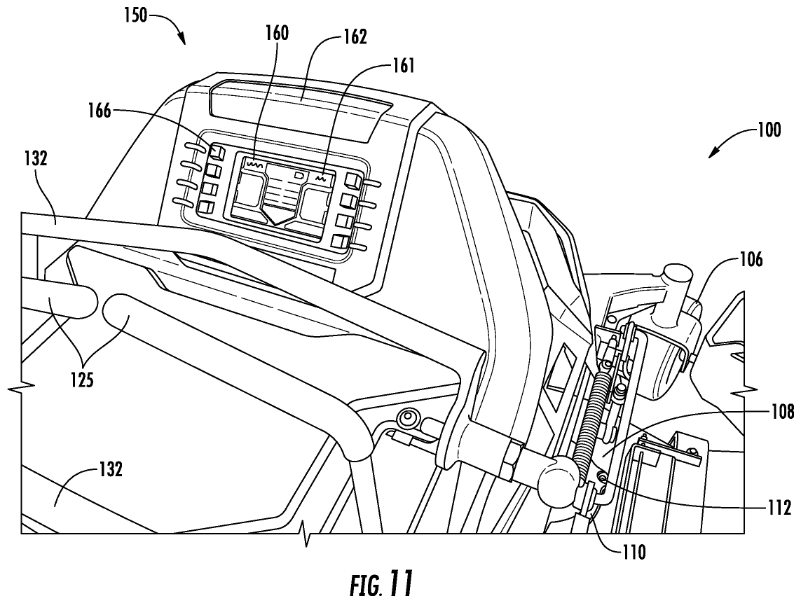

Referring to FIG. 10A, a top schematic view of the cutting deck 108 is shown, according to an exemplary embodiment. An aperture 135 is formed in the cutting deck 108. The aperture 135 includes motor apertures 137 configured to receive the chore motors 110 and a central aperture 139 (e.g., rectangular slot, opening, etc.) spanning between the motors 110. To access the blades 155 (FIGS. 8A-9), an operator can remove the chore motor assemblies 190 (e.g. including both the motor 110 and integrated spindle 175) from the deck 108, and remove the blades 155 through the aperture 135 formed in the deck 108. The operator may pull up one side of the blade 155 and pull out the rest of the blade 155 after rotating the blade 155 a certain angle to fit through the aperture 135. The blades 155 can then easily be sharpened, maintained, and/or replaced without the operator having to go or reach underneath the deck 108. The blades 155 could be coupled to the motor assembly 190 through a quick-release fastener (e.g., snap-on, clip, etc.) such that no tools are needed to remove the blades 155. A cover 141 may be included to conceal the aperture 135 on the cutting deck 108 when not accessed.

Referring to FIGS. 10B-10D, a first blade removal assembly 131 is shown. The blade removal assembly 131 includes a cover 141 configured to conceal the aperture 135 formed in the cutting deck 108 when not accessed. The aperture 135 includes motor apertures 137 configured to receive the chore motors 110 and a central aperture 139 (e.g., rectangular slot, opening, etc.) spanning between the motors 110. The cover 141 includes one or more mechanisms 143 (e.g., quick-release mechanisms, devices, handles, etc.) movable between a locked position and an unlocked position. To remove the cover 141, an operator grasps the quick-release mechanism 143 and moves the mechanisms 143 toward each other as illustrated by arrows 121 shown in FIG. 10B. The mechanisms 143 move into the unlocked position and the cover 141 can be removed as shown in FIG. 10C. To remove the cover 141, the operator lifts directly up (e.g., substantially perpendicular to top surface 107 of deck 108) while grasping the mechanisms 143. The motors 110 and blades 155 can then be removed through the aperture 135 as shown in FIG. 10D.

Referring to FIGS. 10E-10G, a second blade removal assembly 133 is shown. The blade removal assembly 135 includes a cover 151 configured to conceal the aperture 149 formed in the cutting deck 108 when not accessed. The cover 151 includes one or more fasteners 153 (e.g., quick-release fasteners, etc.). The fasteners 153 are configured to be unlocked by the operator such that the operator can grasp the handles 147 positioned on the cover 151 to slide the cover 151 out from the cutting deck 108 as shown in FIG. 10F. The motors 110 and blades 155 are coupled to and move with the cover 151 such that the motors 110 and blades 155 are accessible for maintenance as shown in FIG. 10G.

Referring to FIGS. 11-12, the mower 100 includes a dashboard 150 operable by the operator to control certain operating or performance conditions of the mower 100. The dashboard 150 includes a user interface 160, which displays current operating conditions, maintenance notifications and/or warnings to the operator. The dashboard 150 and user interface 160 are positioned in view of the operator such that when the operator is standing on the platform 128, the operator can clearly see the dashboard 150 and user interface 160 in his or her line of sight. Accordingly, the dashboard 150 and user interface 160 are positioned near the center of the mower 100 proximate the drive levers 125 and handles 132.

The user interface 160 also includes a touchscreen 161 and/or selector interfaces 166 (e.g., push-buttons, toggles, etc.) which may receive input from the operator. The selector interfaces 166 may correspond to similar functions on the touchscreen 161. In some embodiments, an operator interacts with one of the selector interfaces 166 to activate the touchscreen 161. Through interaction with the user interface 160, the operator inputs commands into the control system 200 described in FIGS. 13A-13B, which in turn, controls the mower 100 based on the operator input.

As shown in FIGS. 11-12, in some embodiments, the dashboard 150 can include an indicator 162 (e.g., one or more LEDs) placed proximate the user interface 160 which indicate, via color (e.g., red, yellow, green) a power draw for each of the batteries of the mower 100. In some embodiments, the indicator 162 indicates the operational efficiency with which the operator is operation the mower 100. In some embodiments, if the systems described herein are used on outdoor power equipment which is a hybrid device, the equipment can indicate an amount of motor usage of the motors to the operator. Providing these power draw indications can indicate to an operator which parts of the equipment are using the power and in what amount. The dashboard 150 can include one or more light emitting diodes (LEDs), a display screen (e.g., a LED screen, a touch screen, a resistive touch screen, a capacitive touch screen, etc.), a steering wheel, a throttle control, one or more drive sticks, buttons (e.g., one or more buttons to enable a chore function (e.g., power take-off switch, turn on lawn mower blades, turn off lawn mower blades, select blade speed, start spreader, stop spreader, select spreader speed, turn on compressor, etc.), and/or any other input and/or output device.

Referring to FIG. 13A, a control system 200 for the mower 100 is shown, according to an exemplary embodiment. The control system 200 includes a controller 210 coupled to the user interface 160, the energy storage device 140, the drive motors 127, and the chore motors 110. In some embodiments, the mower 100 also includes other devices communicably and operatively coupled to the controller 210. The control system 200 may communicate with a device, such as a key fob, dongle, smart phone, etc., of the operator such that when the operator is proximate the mower 100, the control system 200 recognizes the device and can activate the user interface 160 and/or the control system 200.

The user interface 160 includes an input/output circuit 214, a display 216, and status indicators 218. The display 216 is a programmable user interface and is used to present operational data, route and/or location information, efficiency information, productivity information, and the like on the dashboard 150 of the mower 100. In this regard, the display 216 is communicably and operatively coupled to the input/output circuit 214 to provide a user interface for receiving and displaying information on the mower 100.

In some embodiments, the user interface 160 is configurable by the operator. In this way, the operator can program in the specific job or a series of jobs (e.g., a day's worth of jobs) to be completed by the mower 100. Accordingly, the operator can input route information and other specific information for the jobsite (e.g., size, incline, etc.). In some embodiments, the display 216 can illustrate the optimum or most efficient route for a particular jobsite. The optimum route may be programmed into the control system 200 by previous operators and/or a system administrator. The optimum route can be displayed to the operator through the user interface 160 as a “ghost” route (e.g., using augmented reality), where the operator can follow along the route by viewing the suggested route through the user interface 160. The display 216 can also provide an indication of the current time, runtime, blade operation time, remaining battery life time, etc., to the operator. The display 216 can also provide an indication of whether the blades 155 are currently operational (e.g., blades are off, blades are on, etc.). In some embodiments, the operator may be required to provide a passcode to enter into the display 216 prior to operating the mower 100. Examples of user interfaces are described more fully herein with regard to FIGS. 14-18.

In some embodiments, the control system 200 may include a database. The database is configured to retrievably store historical operational data for the mower 100. As used herein, “operational data” includes, but is not limited to, battery charge amounts, battery status, voltage level, current draw, motor currents, motor speeds, average motor speeds, runtime, fault conditions, angle of operation, acceleration, power takeoff switch status, one or more indicator lights, tire pressure, air temperature, blade speed, battery temperature, auxiliary temperature, and so on. In some embodiments, the operational parameters include ranges with a maximum and minimum desired value to which a current operating parameter of the mower 100 can be compared. In addition, the mower 100 may include various sensors, such as temperature sensors, angle sensors, acceleration sensors, pressure sensors, etc., to detect current operational data.

The input/output circuit 214 is structured to receive and provide communication(s) to an operator of the mower 100. In this regard, the input/output circuit 214 is structured to exchange data, communications, instructions, etc. with an input/output component of the mower 100. Accordingly, in one embodiment, the input/output circuit 214 includes an input/output device such as a display device, a touchscreen, a keyboard, and a microphone. In another embodiment, the input/output circuit 214 may include communication circuitry for facilitating the exchange of data, values, messages, and the like between an input/output device and the components of the mower 100. In yet another embodiment, the input/output circuit 214 may include machine-readable media for facilitating the exchange of information between the input/output device and the components of the mower 100. In still another embodiment, the input/output circuit 214 may include any combination of hardware components (e.g., a touchscreen), communication circuitry, and machine-readable media.

The status indicators 218 are configured to indicate the status of various components of the mower 100. In some embodiments, the status indicator 218 includes the indicator 162 positioned proximate the user interface 160 on the dashboard 150. The indicator 162 communicates with the operator to indicate an operational efficiency with which the operator is operating the mower 100. The indicator 162 is thus communicably and operatively coupled to an efficiency circuit 224 to receive efficiency and operational data to be displayed by the indicator 162.

As an example, the indicator 162 displays a green light if the operational efficiency is higher than a predetermined efficiency. The indicator 162 may also display a yellow light if the operational efficiency is between a first predetermined efficiency and a second predetermined efficiency. The indicator 162 may also display a red light if the operational efficiency is below the second predetermined efficiency. The indicator 162 may transition between various colors depending on the determined operational efficiency of the mower 100. The operational efficiency may be determined by conditions such as overcharge of the energy storage device 140, overuse of the drive motors 127 or drive wheels 104, and overuse of the chore motors 110 or blades 155. Using the indicator 162, the operator may adjust the way he or she is operating the mower 100 (e.g., adjust speed, load, etc.) and as such, can extend the ride time. The operator may also receive operational data feedback in other ways, such as, but not limited to, through indications on smart glasses, smart watch, etc. Other status indicators 218 can include malfunction warnings, where when lit, store a fault code related to any malfunction detected with the mower 100. In this case, a scan tool can be used for further diagnosis of the malfunction.

The controller 210 is shown to include a processing circuit 202. The processing circuit 202 is shown to include a processor 204 and a memory 206. While the controller 210 is shown to include one processing circuit 202, it should be understood that the controller 210 can include any number of processing circuits 202 and/or the functionality of the processing circuit 202 can be distributed across multiple processing circuits (e.g., across multiple integrated circuits).

The processor 204 can be implemented as a general purpose processor, an application specific integrated circuit (ASIC), one or more field programmable gate arrays (FPGAs), a group of processing components, or other suitable electronic processing components. The memory device 206 (e.g., memory, memory unit, storage device, etc.) is one or more devices (e.g., RAM, ROM, Flash memory, hard disk storage, etc.) for storing data and/or computer code for completing or facilitating the various processes, layers and modules described in the present application. The memory device 206 may be or include volatile memory or non-volatile memory. The memory device 206 may include database components, object code components, script components, or any other type of information structure for supporting the various activities and information structures described in the present application. According to an exemplary embodiment, the memory device 206 is communicably connected to the processor 204 via the processing circuit 202 and includes computer code for executing (e.g., by processing circuit and/or processor) one or more processes described herein.

Referring to FIGS. 13A and 13B, the controller 210 further includes various controller applications 208. The controller applications 208 can include one or more modules configured to perform operations for the controller 210. Each of the modules can communicate data to other controllers, such as motors controllers 115 and/or to a management system 220 included with the energy storage device 140. Furthermore, the controller applications 208 can communicate with the other components of the mower 100, receive data from the chore motors 110 and drive motors 127, and/or operate the chore motors 110 and drive motors 127. The memory 206 can also include a network manager, which can be configured to perform one or more network protocols (e.g., CAN protocols) to enable the controller applications 208 to communicate via a bus.

The controller 210 includes a motor controller circuit 222, an efficiency circuit 224, a mode circuit 226, and a value circuit 228. The motor controller circuit 222 is configured to control the operation of the chore motors 110 and the drive motors 127 via the motor controllers 115 based on inputs received from the user interface 160 and/or dashboard 150. Accordingly, the motor controller circuit 222 is communicably and operatively coupled to the one or more motor controllers 115. The motor controller circuit 222 is configured to communicate with the motor controllers 115 to operate the chore motors 110 and drive motors 127 at varying speeds to perform the functionality of the motors. The chore motors 110 and drive motors 127 are operated separately based on various inputs by an operator. Accordingly, in some embodiments, the motor controller circuit 222 is separately communicably and operatively coupled to the motor controllers 115 of the drive motors 127 and separately communicably and operatively coupled to the motor controllers 115 of the chore motors 110. When a user input is received at the drive levers 125, for example, the controller 210 signals to the motor controllers 115 to drive the drive motors 127 accordingly. In addition, when a user input is received at the user interface 160 to power the chore motors 110, the controller 210 signals to the motor controllers 115 to drive the chore motors 110 accordingly. In some embodiments, the operator may input a single auto-turn input into the user interface 160 (e.g., 90 degree, 180 degree turn, etc.) and the motor controller circuit 222 can control the drive motors 127 to operate the drive wheels 104 to complete the turn.

The efficiency circuit 224 is configured to determine the current operating efficiency of the mower 100, the best operational parameters for how the mower 100 can be operated in certain conditions, and how the efficiency can be improved. The efficiency circuit 224 is also configured to communicate operational efficiency data to the user interface 160 for display, including to the display 216 (e.g., touchscreen) and various status indicators 218, including the indicator 162 positioned proximate the display 216. Accordingly, the efficiency circuit 224 is communicably and operatively coupled to the user interface 160. The efficiency circuit 224 may also communicate with the mode circuit 226 to determine an operator mode selection. This may or may not disable the efficiency circuit 224 communication to the display 216 and/or indicator 162. For example, an operator may select a high-speed mode, where the operator is not concerned with efficient operation, and the efficiency circuit 224 may not communicate operational efficiency data to the user interface 160 for display to the operator.

The efficiency circuit 224 receives operational data, such as blade operating time, sensed load, energy storage device data, charge amounts, energy storage device status, voltage level, current draw, motor currents, motor speeds, average motor speeds, runtime, fault conditions, angle of operation, acceleration, power takeoff switch status, one or more indicator lights, tire pressure, air temperature, blade speed, battery temperature, auxiliary temperature, and so on. The efficiency circuit 224 determines optimum operating conditions for efficient operation. In this way, the efficiency circuit 224 determines optimum operating conditions to extend the runtime of the energy storage device 140 to its maximum life. The efficiency circuit 224 may calculate an efficiency score based on the operational data to display to the operator via the user interface 160. In some embodiments, the efficiency circuit 224 can cause the display 216 to display suggestions to the operator for more efficient operation (e.g., slow down drive speed, slow down blade speed, increase blade speed, etc.).

The mode circuit 226 is configured to receive indications of operator inputs from the user interface 160 and/or selector interfaces 166. In response to the operator inputs, the mode circuit 226 controls one or more functions of the mower 100. In some embodiments, the operator can select a mode of operation using the user interface 160 and/or selector interfaces 166 and in response, the controller 210 controls the mower 100 accordingly. For example, the operator selects an eco-mode. In response, the controller 210 can control the drive wheels 127 (e.g., via motor controllers 115) to limit the wheel ground speed, acceleration rate, etc. The controller 210 may also operate the mower 100 to optimize the efficiency of the mower 100 in response to a selection of an eco-mode.

As another example, the operator may select a performance or high-speed mode, which allows operation of the mower 100 in high speeds without regard to efficiency. In some embodiments, the operator may select a boost mode, which controls the drive speed to a maximum speed. As another example, the operator may input a precision cut mode (or advanced precision cut mode), which indicates that the cut of the grass is prioritized over the speed at which the project is completed. As such, in the precision cut mode, the mode circuit 226 may prioritize control of the speed of the blades 155 (e.g., chore motors 110) over the speed of the drive wheels 104 (e.g., drive motors 127). For example, in the precision cut mode, the mode circuit 226 sets a maximum drive speed limit to maintain a target blade 155 tip speed. In some embodiments, the operator may select a full tilt cut mode, where the maximum blade speed for heavy loads is employed. In some embodiments, the mode circuit 226 may receive an indication the operator has input a “rookie” or “novice” mode. In this case, the mode circuit 226 may control various components of the mower 100 accordingly, such as, limiting the drive speed (e.g., limiting drive motor 127 speed), limiting the turn sensitivity at the drive levers 125, employing turf scrub prevention, etc.

In some embodiments, the controller 210 can receive one or more drive inputs to drive the mower 100 at a particular speed. The drive inputs may indicate an operator-defined drive speed for a first drive wheel and a second drive wheel. The controller 210 and/or multiple other controllers and/or circuits, can operate the drive motors 127 to drive the mower 100 based on the operator-defined drive speed. In addition, in some embodiments, the controller 210 can determine one or more chore motor speeds for a chore motor 110, the chore motor speeds being proportional to the drive speed. In this regard, the speed of a chore device, e.g., the blades 155, can be proportional to how fast the mower 100 (e.g., drive wheels 104) is moving. By adjusting the speed of the chore motor 110, energy can be saved. If the mower 100 is stationary or moving slowly, it may be a waste of energy to operate the blade 155 at a high speed. However, if the mower 100 is moving quickly, the blade 155 may need to operate at the high speed to efficiently cut grass. In this regard, the speed of the chore motor 110 can be based on the drive speed for the mower 100. Alternatively, the chore motors 110 can also be operated independently of the drive motors 127 such that the speed of the blades 155 is controlled separately and independently of the drive speed of the mower 100. This may be beneficial when grass is relatively high, etc.

The value circuit 228 is configured to receive past and current operational data and determine various information relating to the value, warranty information, and/or improper use of the mower 100. Accordingly, the value circuit 228 is communicably and operatively coupled to the circuits discussed herein, as well as various components of the mower 100 that may be monitored, including, but not limited to, chore motors 110, drive motors 127, user interface 160, energy storage device 140, controller 210, motor controllers 115, etc. The value circuit 228 may receive efficiency information from the efficiency circuit 224 to determine the operational data concerning efficiency for previous use. The efficiency value determination can be used to determine a resale value of the mower 100 (e.g., the higher the efficiency values, the higher the resale value, etc.). In addition, the value circuit 228 may retrieve other previous operational data (e.g., stored in a database of the control system 200) to determine a resale value. The value circuit 228 receives past and present operational data and determines if any improper use has occurred, which can be used to determine warranty information (e.g., cancellation of a warranty, extension of a warranty, provide incentives to an operator for proper and efficient use, etc.).

The control system 200 is shown to include a management system 220 included with the energy storage device 140. The management system 220 can be configured to operate the energy storage device 140 to charge and/or discharge. For example, the management system 220 can be configured to cause the energy storage device 140 to be charged based on energy of a charging source. For example, the charging source (e.g., a wall outlet of a home, an outlet of a generator, another battery, etc.) can provide power to the management system 220 which can be configured to cause energy storage device 140 to be charged based on the power sourced from the charging source. Furthermore, the management system 220 can be configured to cause the energy storage device 140 to discharge energy to power and/or operate the motors described herein (e.g., drive motors 127, chore motors 110). In some embodiments, the management system 220 can be configured to monitor various parameters of the energy storage device 140. For example, the management system 220 can be configured to measure, via various sensors (e.g., shunt resistors, voltage sensors, hall effect sensors, thermocouples, thermistors, etc.), a temperature, voltage, current, and/or any other energy storage device parameter.

In some embodiments, the controller 210 also includes a battery manager, which communicates with the management system 212. Based on various battery metrics received from the management system 212, the battery manager can determine whether there is a battery fault and/or whether the energy storage device 140 needs to be charged. For example, if a battery current is greater than a predefined amount, the battery manager can generate an alarm and present the alarm to a user via the user interface 160 or via the indicator 162.

In some embodiments, the controller applications 208 further include a fuel gage circuit. The fuel gage circuit can be configured to generate an indication of the charge of the energy storage device 140 based on battery metrics and/or based on a battery charge received from the management system 220. This operation may also be performed by the efficiency circuit 224 as described above. In some embodiments, the indication is an hours to empty, miles to empty, and/or any other indicator that the fuel gage circuit can be configured to determine based on the battery metrics and/or battery charge received from the management system 220.

In some embodiments, the controller applications 208 further include an incline circuit. The incline circuit is configured to determine the presence of an incline, slope, or hill and communicate that information to the controller 210. The controller 210 may then increase or decrease operation of one or more of the motors 110, 127 based on the incline information. The incline circuit is configured to control the mower 100 to drive in a straight line even when operating on sloped ground. For example, if the mower 100 is driving along the side of a hill (e.g., if the lawn of an operator is sloped and an operator is attempting to cut the grass of the lawn in a straight line), correction may be required to cause the mower 100 to drive in a straight line. The incline circuit can be configured to receive accelerometer data and/or gyroscope data from an accelerometer and/or gyroscope.

The data received from an angle sensing device (e.g., the accelerometer and/or gyroscope) may be indicative of a roll of the mower 100. In this regard, the incline circuit can determine whether the roll is greater than a predefined amount and whether line correction is necessary. In response to determining that the roll is greater than a predefined amount and/or based on the polarity of the roll (whether the mower 100 is rolling clockwise or counterclockwise) the incline circuit can be configured to operate one or more drive wheels (e.g., rear drive wheels 104) to keep the mower 100 driving in a straight line. For example, if the mower 100 is in a roll to the right, the right wheel speed may be a particular amount greater than the left wheel speed. The right wheel speed and/or the left wheel speed may be based on an operator directed drive speed and a magnitude of the roll. Similarly, if the mower 100 is in a roll to the left, the left wheel may be driven at a higher speed than the right wheel to keep the mower 100 driving in a straight line.

In some embodiments, various amounts of roll may indicate that the mower 100 is being operated in a dangerous manner. For example, it may be dangerous for the mower 100 to be riding on a sharp incline since there may be the chance that the mower 100 rolls or flips over and exposes the blades. In this regard, the controller 210 can determine whether the mower 100 is in danger by determining whether a roll angle is greater than a first predefined amount. In response to determining that the roll angle is greater than the first predefined amount, the controller 210 can turn off the chore motors 110 (or cause the motor controllers 115 to turn off chore motors 110). However, the controller 210 may continue to operate the drive motors 127 so that the operator of the mower 100 can correct the dangerous situation. If the controller 210 determine that the roll angle is greater than both the first predefined and a second predefined amount greater than the first predefined amount, this may indicate that the mower 100 is flipping or rolling, has flipped or rolled, or is very likely to flip or roll. In this regard, the controller 210 can be configured to shut down all motors and/or apply braking devices.

In some embodiments, the controller applications 208 also include a straight line circuit. The straight line circuit can receive operator input from the user interface 160 and identify whether the operator is attempting to drive in a straight line. In some embodiments, the user interface 160 and/or selector interfaces 166 include a button causing the straight line circuit to be activated or deactivated. The straight line circuit can receive input from the drive levers 125. The straight line circuit can be configured to determine whether the input from the drive levers 125 are within a predefined amount from each other. If the input from the drive levers 125 are within the predefined amount, the straight line circuit can cause the drive motors 127 of rear drive wheels 104 to operate at the same speed (e.g., based on an average input of the drive levers 125). In some embodiments, the straight line circuit sends a command to motor controllers 115 responsible for controlling the drive motors 127. In some embodiments, the straight line circuit controls one or both of the drive motors 127 directly.

In some embodiments, the controller applications 208 include a hybrid management circuit. The hybrid management circuit can be configured to operate a hybrid device (where the outdoor power equipment is a hybrid device that runs on both a gas engine and a motor with one or more batteries). The hybrid management circuit can receive an indication of the voltage or state of charge (SoC) of the one or more batteries (e.g., from the battery management system 1022) and can be configured to operate a throttle of the gas engine based on the measurement. The hybrid management circuit can be configured to distribute power in a power train of the hybrid system and/or can be configured to operate switching mechanisms causing the one or more batteries to charge and/or discharge in order to use a low (or minimal) amount of gas power.

In some embodiments, the mower 100 includes a global positioning system. The global positioning system can be a satellite-based radio navigation system configured to generate one or more coordinates (e.g., a latitude value, a longitude value, an altitude value) identifying a location of the mower 100. In some embodiments, the global positioning system provides an indication of the coordinates to the controller 210. In some embodiments, the mower 100 includes vehicle lighting systems. For example, the mower 100 can include headlights (e.g., brights, day lights, etc.), brake lights, and/or any other lighting system. In this regard, the controller 210 can be communicably and operatively coupled to and operate the lighting systems of the mower 100.

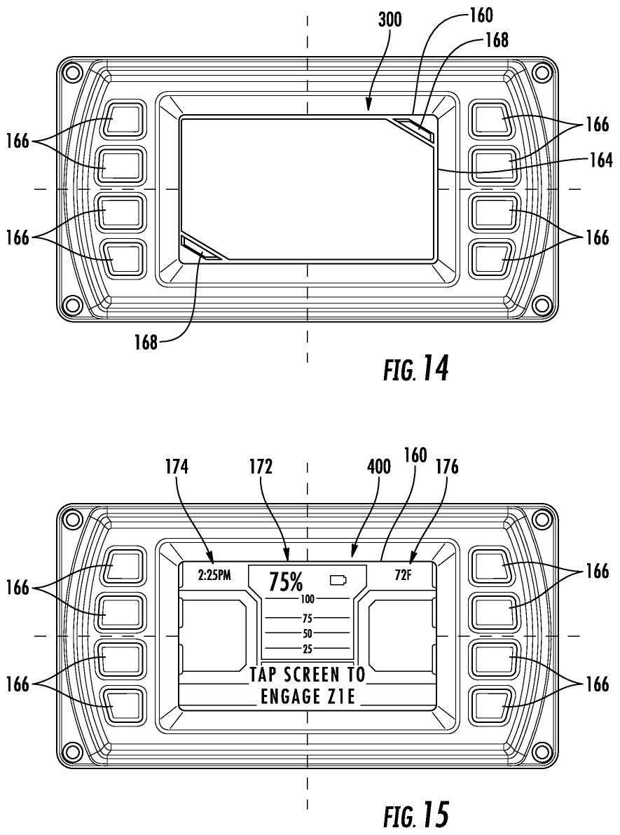

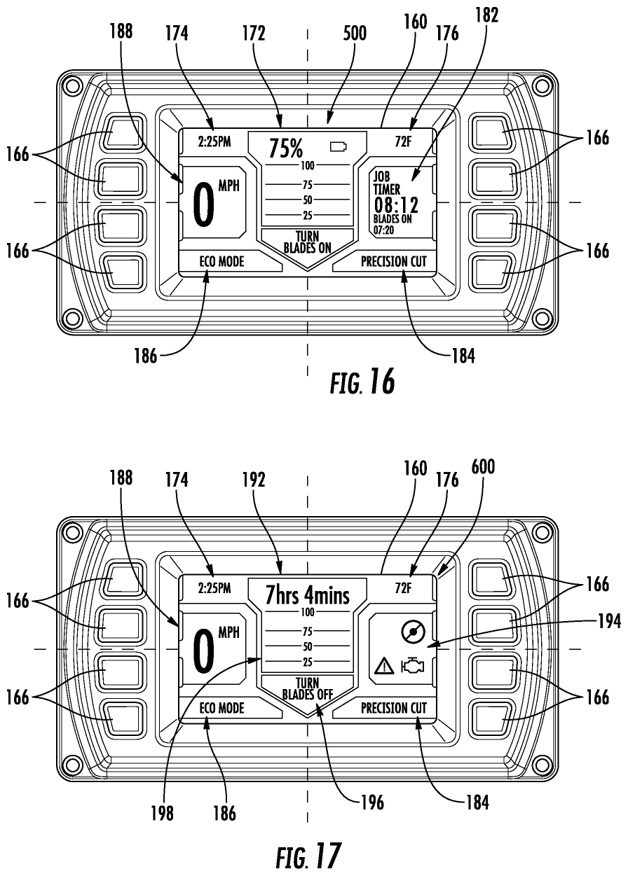

Referring to FIGS. 14-18, various example user interface displays are depicted. The user interface displays depicted in FIGS. 14-18 are used in connection with the control system 200 and mower 100 described in FIGS. 1-13B. Accordingly, description of the user interface displays in FIGS. 14-18 may reference components of one or more of FIGS. 1-13B. In FIG. 14, the user interface display 300 displays a splash screen 164 with outer glowing animation 168. An operator may view this screen upon starting up or activating the user interface 160 by pressing one or the selector interfaces 166, touching the user interface 160, etc. In FIG. 15, the user interface display 400 illustrates a start screen which displays the current time 174, a remaining battery percentage 172, and the ambient temperature 176. An operator may tap the screen to initiate interaction with the user interface 160. Referring to FIG. 16, the user interface display 500 illustrates a base screen, which displays the current time 174, a remaining battery percentage 172, the ambient temperature 176, a job timer 182, a cut mode 184, and an operation mode 186. The job timer 182 may illustrate the total job time, as well as the amount of time the blades 155 have been engaged.

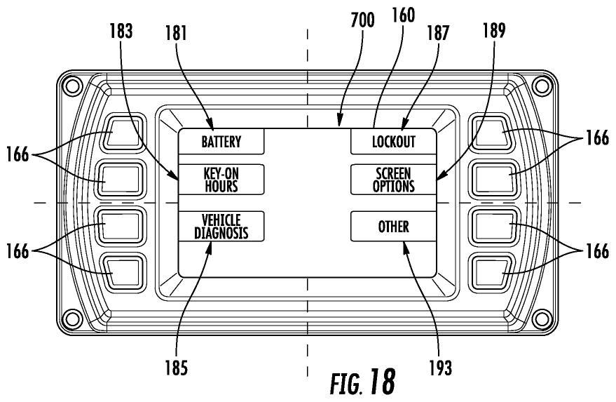

Referring to FIG. 17, the user interface display 600 illustrates a selection screen, which displays the current time 174, the ambient temperature 176, a cut mode 184, an operation mode 186, a drive speed 188, operational time 192, operational data 194, and a blade operation selection 196. By selecting the blade operation selection 196, the operator can turn the blade on or off. In the illustration shown in FIG. 17, if the operator selects the blade operation selection 196 shown, the blades 155 will be turned off. The blade operation selection 196 (e.g., via user interface display 216) is communicably and operatively coupled to the chore motors 110 to control operation thereof. The drive speed 188 is communicably coupled to the drive motors 127 to receive and display drive speed information. The operational data 194 may be communicably coupled to various components of the mower 100, including the blades 155 and/or chore motors 110 to receive an indication of blade operation. In some embodiments, if the operator touches the operational time 192 portion of the screen, the battery charge level is displayed. Referring to FIG. 18, the user interface display 700 illustrates a menu screen, which displays selectable options including, but not limited to, a battery option 181, a key-on hours option 183, a vehicle diagnosis option 185, a lockout option 187, a screen options option 189, and an other option 193.

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

The construction and arrangements of the present disclosure, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A lawnmower comprising:
a cutting deck including an aperture extending through the cutting deck, the aperture comprising a first motor portion, a second motor portion, and a central portion joining the first motor portion and the second motor portion;
a first electric motor received within the first motor portion and coupled to a first cutting blade positioned below the cutting deck; and
a second electric motor received within the second motor portion and coupled to a second cutting blade positioned below the cutting deck.

2. The lawnmower of claim 1, wherein the central portion is substantially rectangular in shape, the first motor portion is substantially circular in shape, and the second motor portion is substantially circular in shape.

3. The lawnmower of claim 2, wherein a width of the central portion is smaller than a diameter of the first motor portion and a diameter of the second motor portion.

4. The lawnmower of claim 1, wherein the first cutting blade is removable through the aperture while coupled to the first electric motor.

5. The lawnmower of claim 1, further comprising a cover removably coupled to the cutting deck to cover the central portion of the aperture.

6. The lawnmower of claim 5, wherein the first electric motor, the second electric motor, and the cover cooperate to cover the entire aperture.

7. The lawnmower of claim 1, wherein the aperture formed from the first motor portion, the second motor portion, and the central portion is a single contiguous aperture that extends completely through the cutting deck.

8. The lawnmower of claim 1, wherein the first cutting blade is removable from beneath the cutting deck upwardly through the aperture while the first cutting blade is coupled to the first electric motor by lifting a first end of the first cutting blade through the aperture and then pulling a remainder of the first cutting blade through the aperture.

9. A lawnmower comprising:
an electric motor configured to operate a component of the lawnmower;
a user interface configured to display operational parameters of the lawnmower,
a controller configured to:
receive input from an operator of the lawnmower via the user interface, the input comprising a selection of an operational mode of a plurality of operational modes; and
control the electric motor differently in response to a selection of each operational mode, wherein the electric motor is connected to the controller via a network communication bus.

10. The lawnmower of claim 9, wherein the network communication bus is a controller area network (CAN) bus.

11. The lawnmower of claim 9, wherein the electric motor is a drive motor and the plurality of operational modes comprise two or more of:
an eco-mode in which a speed of the drive motor is limited to a speed below a maximum rated speed of the drive motor;
a performance mode in which the speed of the drive motor is not limited;
a precision cut mode in which the speed of the drive motor and a speed of a chore motor configured to drive a cutting blade are controlled to maintain a target speed of a tip of the cutting blade; and
a full tilt cut mode in which the chore motor is operated at maximum speed.

12. The lawnmower of claim 9, wherein the electric motor is a drive motor and the controller further comprises an efficiency circuit configured to:
receive operational data for the lawnmower comprising at least one of operating time of a chore motor, operating time of the drive motor, a sensed load, data regarding an energy storage device configured to power the chore motor and the drive motor; storage levels of the energy storage device, a status of the energy storage device, and voltage level, current draw, speeds and average speeds of the chore motor and the drive motor, fault conditions, acceleration of the lawnmower, pressure of a tire of the lawnmower, air temperature, or a temperature of the energy storage device;
determine, based on the operational data, a recommendation to adjust at least one of a speed of the drive motor or a speed of the chore motor to extend a runtime of the energy storage device; and
cause the user interface to display the recommendation.

13. The lawnmower of claim 12, wherein the operational data comprises an indication of a reduction in the speed of the drive motor, wherein the controller is configured to control the chore motor to reduce a speed of the chore motor in response to receiving the indication of the reduction in the speed of the drive motor.

14. The lawnmower of claim 9, wherein the electric motor is a drive motor, wherein in a first operational mode, the controller controls the speed of a chore motor in proportion to the speed of the drive motor, and in a second mode, the controller controls the speed of the chore motor independent of the speed of the drive motor.

15. The lawnmower of claim 14, wherein the chore motor is connected to the controller via the network communication bus and configured to drive a cutting blade and the drive motor is connected to the controller via the network communication bus and configured to drive a drive wheel.

16. The lawnmower of claim 9, wherein the controller is configured to:
receive operational data regarding the lawnmower;
determine an operational efficiency of the lawnmower based on the operational data; and
cause the user interface to display an indication of the operational efficiency.

17. The lawnmower of claim 16, wherein the user interface comprises a light-emitting diode (LED) configured to emit a plurality of colors, the controller configured to cause the LED to change colors based on the determined operational efficiency.

18. A lawnmower comprising:
a cutting deck;
a cutting blade positioned below the cutting deck;
an electric motor configured to drive the cutting blade; and
a motor spindle coupled to the cutting blade and integrally formed with the electric motor.

19. The lawnmower of claim 18, wherein the electric motor and spindle share two bearings.

20. The lawnmower of claim 18, wherein the motor spindle is positioned below the cutting deck, and the electric motor is coupled to and positioned at least partially below the cutting deck.
